(19) United States
(12) Patent Application Publication
(10) Pub. No.: US 2026/0287408 A1
(43) Pub. Date: Sep. 24, 2026

(54) METHOD FOR ESTIMATING THE VOLUME OF A PRESSURIZED GAS TANK

(71) Applicant: L'Air Liquide, Societe Anonyme pour l'Etude et l’Exploitation des Procedes Georges Claude, Paris (FR)

(72) Inventors: Remi GONIN, Paris (FR); Fouad AMMOURI, Paris (FR); David VEMPAIRE, Paris (FR)

(21) Appl. No.: 19/562,257

(22) Filed: Mar. 10, 2026

(30) Foreign Application Priority Data
Mar. 19, 2025 (FR) FR2502789

(51) Int. Cl. G01F 22/02

(52) U.S. Cl. CPC G01F 22/02

(57) ABSTRACT

Method for estimating the volume of a pressurized gas tank, the method comprising an injecting step and a step of calculating the volume of the tank depending on:
i) the initial pressure (p₀) of the gas in the tank,
ii) the initial temperature (T₀) of the gas in the tank,
iii) an amount (Δm) of gas flow injected into the tank,
iv) the temperature (T_inj) of injection of the gas flow into the tank,
v) the variation (Δp) in the pressure of the gas in the tank,
wherein the calculating step also uses the duration (Δt) of the injecting step, said duration (Δt) being defined between a time (t₁) marking the end of the injecting step and a time (t₀) marking the beginning of the injecting step.

### CROSS REFERENCE TO RELATED APPLICATIONS

This application claims the benefit of priority under 35 U.S.C. § 119 (a) and (b) to French patent application No. FR2502789, filed Mar. 19, 2025, which is herein incorporated by reference in its entirety.

### FIELD OF THE INVENTION

The invention relates to a method for estimating the volume of a pressurized gas tank, in which the filling duration is taken into account.

The method according to the invention is in particular applicable to the field of filling tanks for fuel cell vehicles (FCVs) at a hydrogen refuelling station (HRS).

### BACKGROUND OF THE INVENTION

Before filling a tank at a refuelling station, it is necessary to know the total volume of this tank precisely, and to select the most fitting filling protocol accordingly. The volume-related datum and selection of the fitting protocol allows performance to be improved.

The vehicle may transmit a datum related to the volume of the tank to the refuelling station, as recommended by standard J2799 of the Society of Automotive Engineers (SAE). In the absence of transmission of a volume datum by the vehicle, or for the purpose of verifying the reliability of a volume datum received from the vehicle, the refuelling station may estimate this volume itself.

The volume of the tank is estimated by the refuelling station during a start-up time.

To do so, at a time to [s], the pressures of the refuelling station (and more specifically of a dispenser of the refuelling station) and of the tank to be filled are brought into equilibrium.

The equilibrium thus obtained makes it possible to determine a first pressure p₀ [Pa] in the tank. After equilibrium has been reached, a step of injecting a mass Δm [kg] of gas into the tank is carried out.

Following this injection, at a time t₁ [s] subsequent to the time to [s], the pressures of the dispenser of the station and of the tank are once again brought into equilibrium, allowing a second pressure p₁ [Pa] in the tank to be determined.

The volume V [m³] of the tank may thus be calculated in the following way:

$$V = \frac{Δ m}{ρ ( {p}_{1} , {T}_{1} ) - ρ ( {p}_{0} , {T}_{0} )} \qquad ( 1 )$$

with
ρ [kg/m³] the density of the gas,
ρ(p₁,T₁)−ρ(p₀,T₀), the difference in density between times t₀ and t₁,
T₀[K], the temperature at time to, considered equal to ambient temperature, and
T₁[K] the temperature at time t₁, estimated via assumptions or correlations.

A first difficulty associated with this method of estimating the volume V of the tank is that filling causes the gas in the tank to heat up. The temperature T₁ of the gas at the time t₁ is therefore necessarily higher than its temperature T₀ at the time t₀.

To predict the temperature T₁, it is necessary to model heat transfer between the gas in the tank and the walls of the tank, thermal conduction in the walls of the tank, and heat transfer between the walls of the tank and the external environment. To carry out such modelling, it is necessary to know the thermal and geometric properties of the tank, which are not known in advance by the refuelling station.

In the absence of data on the thermal and geometric properties of the tank, a first approach is to neglect the temperature rise. This amounts to assuming that T₁ is close to T₀ (i.e. T₁=T₀). Such an approximation is justified if the step of estimating the volume V of the tank is followed by a long rest period.

The above assumption, known as isothermal filling, allows formula (1) above to be expressed in the following way:

$${V}_{iso} = \frac{Δ m}{ρ ( {p}_{1} , {T}_{0} ) - ρ ( {p}_{0} , {T}_{0} )} , \qquad ( 2 )$$

Since density ρ [kg/m³] decreases with temperature, the isothermal filling assumption tends to underestimate the volume V of the tank.

A second approach, described in a patent application (FR 2307995) filed by the applicant, consists in neglecting heat transfer between the gas and the inner walls of the tank, and in taking into account the temperature Tᵢₙⱼ [° C.] of the injected gas. This assumption, referred to as the adiabatic assumption, is justified if the step of estimating volume is rapid.

The adiabatic filling assumption leads to overestimation of the volume V of the tank, and relationship (1) above being expressed as follows:

$${V}_{adia} = f ( {T}_{0} , {p}_{0} , {T}_{inj} ) \frac{Δ m}{Δ p} , \qquad ( 3 )$$

$$with$$

$$Δ p = {p}_{1} - {p}_{0}$$

and
ƒ [MPa·L/kg] a function defined in a polynomial form resulting from physical modelling.

A third approach, proposed by Handa et al. (See “S. Yamaguchi, Y. Fujita, K. Handa. New Tank Volume Estimation Method for Hydrogen Fueling. Society of Automotive Engineers of Japan, presented at EVS 31 & EVTeC 2018, Kobe, Japan, Oct. 1-3, 2018”), or by SAE J2601-5 (see “SAE International Information Report, High-Flow Prescriptive Fueling Protocols for Gaseous Hydrogen Powered Medium and Heavy-Duty Vehicles, SAE Standard J2601/5_202402, issued February 2024, https://doi.org/10.4271/J2601/5_202402.”), consists in expressing the temperature T₁ as a function of the initial pressure p₀, then injecting the expression for T₁ into relationship (1) above.

The relationship between the temperature T₁ and the initial pressure p₀ may be written as follows:

$${T}_{1} = {T}_{0} + 27.79 - 1.4867 {p}_{0} + 0.03834 {p}_{0}^{2} - 0.0003513 {p}_{0} , \qquad ( 4 )$$

with p₀ [MPa].

A second difficulty associated with the method for estimating the volume V lies in the fact that the pressure p₁ at the time t₁ must be quite high compared to the pressure p₀ at the time to, so as to allow, depending on the accuracy of the pressure sensor with which the dispenser is equipped, a good evaluation of the difference in density between the times t₀ and t₁.

However, the pressure rise Δp depends on the mass Δm of gas injected into the tank, and on the volume V of the tank. Handa et al. in “S. Yamaguchi, Y. Fujita, K. Handa. New Tank Volume Estimation Method for Hydrogen Fueling. Society of Automotive Engineers of Japan, presented at EVS 31 & EVTeC 2018, Kobe, Japan, Oct. 1-3, 2018”) show that in order to achieve a pressure rise of more than 2.5 MPa in the tank, the mass Δm may well exceed 200 g, in particular when the volume of the tank is more than 100 L.

During the start-up time, the injected hydrogen mass must remain less than 200 g. This constraint requires the step of estimating volume to be carried out outside of the start-up time in order to allow a sufficient pressure rise and satisfactory evaluation of the difference in density between the times t₀ and t₁.

To meet this constraint, SAE J2601-5 makes provision to estimate the volume V of a tank while actually filling it, and not solely during the start-up time. To do this, a slow pressure ramp that varies with the ambient temperature is selected.

However, implementation of such a pressure ramp excludes the possibility of estimating the volume of a tank in the case of adiabatic filling. Likewise, estimating the volume in the case of isothermal filling is also not envisageable, because the rest period, once the pressure in the dispenser has been reached, is insufficient to allow the temperature in the tank to return to ambient temperature.

Moreover, it has been established that the estimation of the temperature T₁ according to the method recommended by SAE J2601-5 is also unsatisfactory. Specifically, the estimated temperature does not depend on the rise in pressure in the tank. Furthermore, this estimated temperature is not dependent on the temperature of injection, nor the filling duration.

However, the initial pressure has an effect on the speed of the injected gas, and therefore on the head loss between the dispenser of the station and the tank. In other words, at high pressure, the pressures at the dispenser of the station and in the tank will be similar. The pressure difference needed in the tank to apply the volume estimation will be reached more quickly.

As for the ambient temperature, which is between −40° C. and 50° C. in the SAE tables (see SAE International Technical Standard, Fueling Protocols for Light Duty Gaseous Hydrogen Surface Vehicles, SAE Standard J2601_202005, revised May 2020, issued March 2010, https://doi.org/10.4271/J2601_202005), it affects the most conservative pressure ramp. For example, for a certain type of refuelling station, the most conservative ramp is 15.7 MPa/min at an ambient temperature of −40° C., whereas it is 1.2 MPa/min at an ambient temperature of 50° C.

Lastly, as far as the filling duration is concerned, it may vary widely depending on the initial pressure, i.e. the initial density of the gas in the tank, and on the ambient temperature. Not taking this parameter into account leads to a less accurate estimate of the volume.

Finally, during the injection of the gas into the tank between the times t₀ and t₁, the pressure in the tank may be much lower than the pressure measured at the dispenser, in particular due to head loss in the filling pipe, essentially during potential choking. In order to take this head loss into account, and to accurately determine the rise Δp in the pressure in the tank, the literature proposes various correlations between the pressure rise Δp_{disp} [MPa] at the dispenser and the initial pressure p₀ [MPa] in the tank. However, the pressure rise thus obtained is not always accurate.

One example of such a correlation, described in “SAE International Information Report, High-Flow Prescriptive Fueling Protocols for Gaseous Hydrogen Powered Medium and Heavy-Duty Vehicles, SAE Standard J2601/5_202402, issued February 2024, https://doi.org/10.4271/J2601/5_202402”, is given below, where the rise Δp_{disp} [MPa] in the pressure at the dispenser of the refuelling station depends on the initial pressure p₀ [MPa] in the tank:

$$Δ {p}_{disp} = {p}_{0} + 13.03 - 0.3642 {p}_{0} + 0.007208 {p}_{0}^{2} - 0.00000542 {p}_{0}^{3} \qquad ( 5 )$$

### SUMMARY OF THE INVENTION

There is therefore a need to develop a method for estimating the volume of a tank to be filled, that will allow the most accurate possible estimation of the tank.

To this end, the invention introduces a method for estimating the volume of a pressurized gas tank. The method comprises the following steps:
a) determining the initial pressure of the gas in the tank,
b) determining the initial temperature of the gas in the tank,
c) injecting a pressurized gas flow into the tank,
d) determining the temperature of injection of the gas flow into the tank,
e) determining the amount of gas flow injected into the tank during the injecting step,
f) determining the variation in the pressure of the gas in the tank, between a final pressure determined at the end of the injecting step and the initial pressure determined at the beginning of the injecting step,
g) calculating the volume of the tank depending on:
i) the initial pressure of the gas in the tank,
ii) the initial temperature of the gas in the tank,
iii) the temperature of injection of the gas flow into the tank,
iv) the mass of the gas flow injected into the tank,
v) the variation in the pressure of the gas in the tank.

According to the invention, the calculating step also uses the duration of the injecting step, said duration being defined between a time marking the end of the injecting step and a time marking the beginning of the injecting step.

Embodiments of the invention may have one or more of the following features:
the step of calculating the volume also uses a predetermined parameter taking into account both the geometry and the material of the tank;
the predetermined parameter is the product of a characteristic length of the tank multiplied by a coefficient of heat transfer between the pressurized gas and an inner wall of the tank;
the characteristic length has a value between a lower bound associated with a first reference tank of spherical shape, and an upper bound associated with a second reference tank of cylindrical shape;
the lower bound of the characteristic length is equal to one third of a first internal radius of the first reference tank of spherical shape;
the upper bound of the characteristic length is equal to half a second internal radius of the second reference tank of cylindrical shape;
the coefficient of heat transfer has a value between a predetermined lower bound equal to 150 W/m²/K, and a predetermined upper bound equal to 10,000 W/m²/K;
the step of determining the temperature of injection of the gas into the tank is carried out using a temperature sensor placed in a refuelling station to which the tank is connected;
the initial temperature is estimated to be equal to the ambient temperature in a region surrounding the tank;
the step of calculating the volume of the tank uses a mathematical function or formula V obtained from a mass and energy conservation balance of the gas injected into the tank;
the V function is expressed as follows:

$$V = \frac{1}{{t}_{1} - {t}_{0}} {\int }_{{t}_{0}}^{{t}_{1}} \frac{[ 1 - \frac{\partial ρ}{\partial T} \vert p [ \frac{( h ( p , {T}_{inj} ) - h ( p , T ) )}{ρ {c}_{p} + Λ ( t - {t}_{1} )} ] ]}{[ \frac{\partial ρ}{\partial p} \vert T + \frac{\partial ρ}{\partial T} \vert p [ \frac{β T}{ρ {c}_{p} + Λ ( t - {t}_{1} )} ] ]} dt \frac{dm}{dp}$$

with
ρ [kg/m³] the density of the gas,
T [K] the temperature of the gas,
p [bar] the pressure of the gas,
t [s] time,
cₚ [J/K/kg] the heat capacity of the gas,
β [1/K] the isobaric expansion coefficient of the gas,
h [J/kg] the enthalpy of the gas,
Tᵢₙⱼ [K] an average over time of the temperature of the injected gas,
Λ [W/m³/K] a parameter taking into account the geometry and material of the tank;
the function V takes one of the following two forms V_{adia} and Vᵢₛₒ depending on the filling time:
when the filling time tends to zero (filling achieved in less than 5 seconds), the function V takes the following form V_{adia}:

$${V}_{adia} = \frac{[ 1 - \frac{\partial ρ}{\partial T} \vert p [ \frac{( h ( p , {T}_{inj} ) - h ( p , T ) )}{ρ {c}_{p}} ] ]}{[ \frac{\partial ρ}{\partial p} \vert T + \frac{\partial ρ}{\partial T} \vert p [ \frac{β T}{ρ {c}_{p}} ] ]} \frac{Δ m}{Δ p} ;$$

when the filling time tends towards infinity (filling time greater than 20 minutes), the function (V) takes the following form (Vᵢₛₒ):

$${V}_{iso} = \frac{1}{[ \frac{\partial ρ}{\partial p} \vert T ]} \frac{Δ m}{Δ p}$$

### BRIEF DESCRIPTION OF THE DRAWINGS

The invention will be understood better from reading the following description and from studying the accompanying figures. These figures are given only by way of illustration and do not in any way limit the invention.

FIG. 1 schematically illustrates a vehicle tank connected to a refuelling station;

FIG. 2 illustrates steps of a method according to the invention, for estimating the volume of the tank illustrated in [FIG. 1].

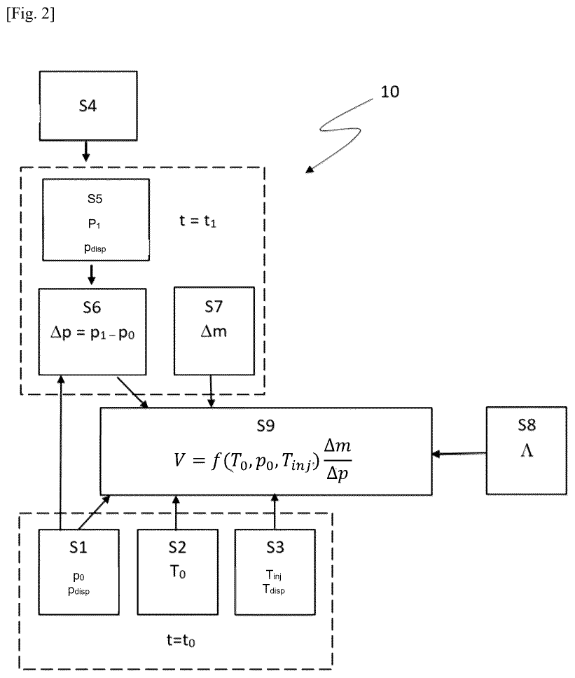

### DETAILED DESCRIPTION OF THE INVENTION

In certain embodiments, the invention relates to a method 10 for estimating the volume of a pressurized gas tank 2. The gas in question may be hydrogen. The tank 2 is then a pressurized hydrogen tank or compressed hydrogen storage system (CHSS).

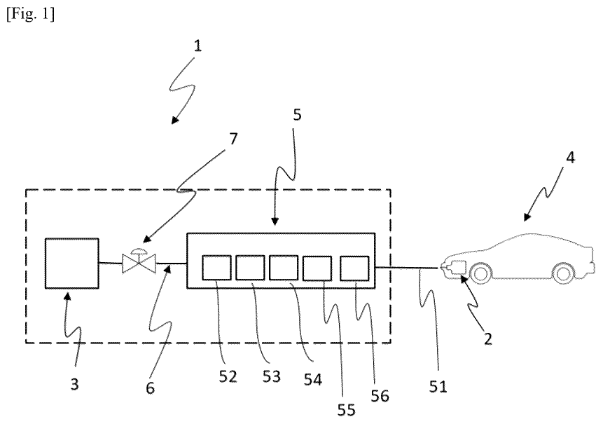

The tank 2 may be that of a fuel-cell vehicle 4. It may be a question of a single tank or of a set of tanks with which the vehicle 4 is equipped. Furthermore, the tank 2 may be supplied by a refuelling station 1, as shown in [FIG. 1].

The refuelling station 1 comprises a gas source 3 and a dispenser 5 intended to receive the vehicle 4.

The dispenser 5 is connected to the gas source 3 by means of a transfer line 6 that comprises at least one control member 7 controlling the pressure and/or the flow rate of the fluid. Furthermore, the dispenser 5 comprises a supply pipe 51 provided at its end with a nozzle intended to be received in a receptacle belonging to the tank 2. The dispenser 5 may be equipped with a pressure sensor 52 for sensing the pressure of the transferred fluid, with a temperature sensor 53 for sensing the temperature of the transferred fluid, with a flow sensor 54 for sensing the mass flow rate of the transferred fluid, with a temperature sensor 55 for sensing the ambient temperature, and with a valve 56.

The method 10 comprises a step S1 of determining the initial pressure p₀ of the gas in the tank 2, a step S2 of determining the initial temperature T₀ of the gas in the tank 2, and a step S3 of determining the temperature Tᵢₙⱼ of injection.

The initial pressure p₀ in the tank 2 may be determined using the pressure sensor 52 installed in the dispenser 5 of the refuelling station 1.

The temperature T₀ of the gas in the tank 2 may be considered equivalent to the ambient temperature measured in a region surrounding the tank 2. It may therefore be measured by the temperature sensor 54 with which the dispenser 5 is equipped, or by any other temperature sensor located in the region surrounding the refuelling station 1.

As for the temperature Tᵢₙⱼ of injection, it may advantageously be determined using the temperature sensor 53 with which the dispenser 5 is equipped.

The method 10 comprises a step S4 of injecting a pressurized flow of fluid into the tank 2 to be filled, using the dispenser 5. In particular, the injecting step S4 lasts a duration Δt defined between a time t₀ marking the beginning of the injecting step S4 and a time t₁ marking the end of the injecting step S4.

In order to inject gas into the tank 2 from the refuelling station 1, the control member 7 controlling pressure and/or flow rate and the valve 53 are kept open.

At the end of the injecting step S4, the method 10 makes provision for a step S6 of determining the variation Δp in pressure in the tank 2, between the initial pressure p₀ determined at the time t₀, in step S1 prior to the injecting step, step S4, and a final pressure p₁ determined at the time t₁, in a step S5 subsequent to the injecting step S4.

Likewise, the method 10 makes provision for a step S7 of determining an amount Δm of fluid flow injected into the tank 2.

Lastly, the method 10 makes provision for a step S9 of calculating the volume V of the tank 2 as a function of the parameters determined above, namely the initial pressure p₀ and the initial temperature T₀ of the gas in the tank 2, the temperature Tᵢₙⱼ of injection of the fluid flow into the tank 2, the mass Δm of the injected fluid flow, and the pressure variation Δp.

It should be noted that the temperature Tᵢₙⱼ of injection of the fluid flow into the tank 2 may be determined during or after the step S4 of injecting the gas into the tank 2, and not necessarily in step S1 prior to the injecting step S4.

According to the invention, the step S9 of calculating the volume V of the tank 2 also uses the duration Δt of the injecting step.

The volume V of the tank 2 is then expressed as follows:

$$V = f ( {T}_{0} , {p}_{0} , {T}_{inj} , Δ t ) \frac{Δ m}{Δ p} , \qquad ( 6 )$$

with ƒ(T₀, p₀, Tᵢₙⱼ, Δt) a function that depends on the initial temperature T₀ [° C.] and initial pressure p₀ [MPa] of the gas in the tank 2, on the temperature Tᵢₙⱼ [° C.] of the gas injected into the tank 2, and on the filling duration Δt [s].

The function ƒ(T₀, p₀, Tᵢₙⱼ, Δt) may be obtained from a conservation balance of the mass m and energy of the gas injected into the tank 2, as described below. It then depends on the thermophysical properties of the gas.

As a variant, the function ƒ(T₀, p₀, Tᵢₙⱼ, Δt) may be obtained via an interpolating polynomial.

Advantageously, the step S9 of calculating the volume V also uses a predetermined parameter Λ that takes into account both the geometry and the material of the tank 2. This parameter Λ is determined in a step S8, prior to step S9. Depending on the predetermined value of the parameter Λ, the estimate of the volume V will be either an overestimate or an underestimate, depending on the final need.

More specifically, the parameter Λ is the product of a characteristic length l_{c} of the tank 2 multiplied by a coefficient k_{g} of heat transfer between the pressurized gas and an inner wall of the tank 2. The characteristic length l_{c} is for example expressed in metres. The coefficient k_{g} of heat transfer is for example expressed in watts per metres squared per kelvin [W/m²/K]. Thus, the predetermined parameter Λ may be expressed in watts per metres cubed per kelvin [W/m³/K].

The characteristic length l_{c} has a value between a lower bound associated with a first reference tank of spherical shape, and an upper bound associated with a second reference tank of cylindrical shape. The calculation of the lower bound and upper bound of the characteristic length is presented below.

As for the coefficient k_{g} of heat transfer between the pressurized gas and the inner wall of the tank 2, it has a value between a predetermined lower bound equal to 150 W/m²/K, and a predetermined upper bound equal to 10,000 W/m/K.

Definition of the function ƒ(T₀, p₀, Tᵢₙⱼ, Δt)

The objective of the present section is to detail the calculational steps allowing the function ƒ(T₀, p₀, Tᵢₙⱼ, Δt) serving to estimate the volume V of tank 2 to be constructed.

Assuming the gas to be a volume of uniform temperature and pressure, i.e. of uniform density, the mass m [kg] of the gas in the tank 2 may be written as follows:

$$m = ρ V , \qquad ( 7 )$$

with

$$ρ [ \frac{kg}{{m}^{3}} ]$$

the density of the gas, and
V[m³] the volume of the tank 2, which is constant.
   The following may be written:

$$dm = V [ \frac{\partial ρ}{\partial p} {\vert}_{T} dp + \frac{\partial ρ}{\partial T} {\vert}_{p} dT ] , \qquad ( 8 )$$

$$and therefore$$

$$\dot{m} = V [ \frac{\partial ρ}{\partial p} {\vert}_{T} \frac{dp}{dt} + \frac{\partial ρ}{\partial T} {\vert}_{p} \frac{dT}{dt} ] , \qquad ( 9 )$$

with

$$\dot{m} [ \frac{kg}{s} ]$$

the injected mass flow rate,
T[K] the temperature of the gas, and
p the pressure in the gas, and
t[s] time.

To evaluate the expression , a mass and energy conservation balance is applied to the volume of gas.

The mass conservation equation is written:

$$\frac{dm}{dt} = \dot{m} , \qquad ( 10 )$$

and the energy conservation equation is written:

$${mc}_{p} \frac{dT}{dt} = V β T \frac{dp}{dt} + {k}_{g} {S}_{w} ( {T}_{g , w} - T ) + \dot{m} ( h ( p , {T}_{inj} ) + \frac{{{u}_{inj}}^{2}}{2} - h ( p , T ) ) , \qquad ( 11 )$$

with
cₚ[J/K/kg] the heat capacity of the gas,

$$β [ \frac{1}{K} ]$$

the isobaric expansion coefficient of the gas,
kg[W/m²/K] the coefficient of heat transfer between the gas and the inner wall of the tank 2,
S_{w} [m²] the area of the inner wall of the tank 2,
T_{g,w} [K] the average temperature of the inner wall of the tank 2,
h[J/kg] the enthalpy of the gas,
Tᵢₙⱼ [K] the temperature of the injected gas, and
uᵢₙⱼ[m/s] the speed of the injected gas.

The kinetic energy of the injected gas may be neglected compared to the enthalpy difference, i.e.

$$\frac{{{u}_{inj}}^{2}}{2} << h ( p , {T}_{inj} ) - h ( p , T ) , \qquad ( 12 )$$

Relationship (11) then becomes:

$${mc}_{p} \frac{dT}{dt} = V β T \frac{dp}{dt} + {k}_{g} {S}_{w} ( {T}_{g , w} - T ) + \dot{m} ( h ( p , {T}_{inj} ) - h ( p , T ) ) , \qquad ( 13 )$$

Relationship (13) may be divided by mcₚ,

$$\frac{dT}{dt} = \frac{V β T}{{mc}_{p}} \frac{dp}{dt} + \frac{{k}_{g} {S}_{w} ( {T}_{g , w} - T )}{{mc}_{p}} + \dot{m} \frac{h ( p , {T}_{inj} ) - h ( p , T )}{{mc}_{p}} , \qquad ( 14 )$$

The temperature difference T−T_{g,w} between the gas and the wall of the tank is approximated by the variation in the temperature of the gas. Specifically, it is probable that, at the beginning of filling, the temperatures of the gas and wall are very close. The temperature difference T−T_{g,w} will be created when the temperature of the gas increases.

Thus, the following may be written:

$$T - {T}_{g , w} \approx dT , \qquad ( 15 )$$

Relationship (14) may be subjected to the following transformations:

$$\frac{dT}{dt} = \frac{V β T}{{mc}_{p}} \frac{dp}{dt} - \frac{{k}_{g} {S}_{w} dT}{{mc}_{p}} + \dot{m} \frac{h ( p , {T}_{inj} ) - h ( p , T )}{{mc}_{p}} , \qquad ( 16 )$$

$$then ,$$

$$\frac{dT}{dt} = \frac{V β T}{{ρ Vc}_{p}} \frac{dp}{dt} - \frac{{k}_{g} {S}_{w} δ t}{{ρ Vc}_{p}} + \dot{m} \frac{h ( p , {T}_{inj} ) - h ( p , T )}{{ρ Vc}_{p}} , \qquad ( 17 )$$

with δt [s] an elementary change in time.

### Thus,

$$\frac{dT}{dt} = [ \frac{{ρ c}_{p}}{{ρ c}_{p} + {k}_{g} \frac{{S}_{w}}{V} δ t} ] [ \frac{β T}{{ρ c}_{p}} \frac{dp}{dt} + \dot{m} \frac{h ( p , {T}_{inj} ) - h ( p , T )}{{ρ Vc}_{p}} ] , \qquad ( 18 )$$

$$then ,$$

$$\frac{dT}{dt} = [ \frac{1}{{ρ c}_{p} + {k}_{g} \frac{{S}_{w}}{V} δ t} ] [ β T \frac{dp}{dt} + \dot{m} \frac{h ( p , {T}_{inj} ) - h ( p , T )}{V} ] \qquad ( 19 )$$

It is then possible to inject (19) into (9),

$$\dot{m} = V [ \frac{\partial ρ}{\partial T} \vert T \frac{dp}{dt} + \frac{\partial ρ}{\partial T} \vert p [ \frac{1}{{ρ c}_{p} + {k}_{g} \frac{{S}_{w}}{V} δ t} ] [ β T \frac{dp}{dt} + \dot{m} \frac{h ( p , {T}_{inj} ) - h ( p , T )}{V} ] ] , \qquad ( 20 )$$

then to rearrange (20) to reveal the relationship between mass flow rate and the variation in pressure,

$$\dot{m} = V [ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ] \frac{dp}{dt} + \dot{m} V \frac{\partial ρ}{\partial T} \vert p [ \frac{( h ( p , {T}_{inj} ) - h ( p , T ) )}{v ( {ρ c}_{p} + {k}_{g} \frac{{S}_{w}}{V} δ t )} ] , \qquad ( 21 )$$

$$\dot{m} = V [ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ] \frac{dp}{dt} + \dot{m} V \frac{\partial ρ}{\partial T} \vert p [ \frac{( h ( p , {T}_{inj} ) - h ( p , T ) )}{v ( {ρ c}_{p} + {k}_{g} \frac{{S}_{w}}{V} δ t )} ] , \qquad ( 22 )$$

$$\dot{m} = [ 1 - \frac{\partial ρ}{\partial T} \vert p [ \frac{( h ( p , {T}_{inj} ) - h ( p , T ) )}{{ρ c}_{p} + {k}_{g} \frac{{S}_{w}}{V} δ t} ] ] = V [ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ] \frac{dp}{dt} , \qquad ( 23 )$$

$$\frac{dp}{dt} = \frac{[ 1 - \frac{\partial ρ}{\partial T} \vert p [ \frac{( h ( p , {T}_{inj} ) - h ( p , T ) )}{{ρ c}_{p} + {k}_{g} \frac{{S}_{w}}{V} δ t} ] ]}{[ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ]} \dot{m} \qquad ( 24 )$$

$$Thus ,$$

$$V \frac{dp}{dt} = \frac{[ 1 - \frac{\partial ρ}{\partial T} \vert p [ \frac{( h ( p , {T}_{inj} ) - h ( p , T ) )}{{ρ c}_{p} + {k}_{g} \frac{{S}_{w}}{V} δ t} ] ]}{[ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ]} \dot{m} dt \qquad ( 25 )$$

$$and finally ,$$

$$V {\int }_{{t}_{0}}^{{t}_{1}} \frac{dp}{dt} dt = {\int }_{{t}_{0}}^{{t}_{1}} \frac{[ 1 - \frac{\partial ρ}{\partial T} \vert p [ \frac{( h ( p , {T}_{inj} ) - h ( p , T ) )}{{ρ c}_{p} + {k}_{g} \frac{{S}_{w}}{V} δ t} ] ]}{[ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ]} \dot{m} dt \qquad ( 26 )$$

$$V Δ p = {\int }_{{t}_{0}}^{{t}_{1}} \frac{[ 1 - \frac{\partial ρ}{\partial T} \vert p [ \frac{( h ( p , {T}_{inj} ) - h ( p , T ) )}{{ρ c}_{p} + {k}_{g} \frac{{S}_{w}}{V} δ t} ] ]}{[ \frac{\partial ρ}{\partial T} \vert T + \frac{\partial ρ}{\partial T} \vert p [ \frac{β T}{{ρ c}_{p} + {k}_{g} \frac{{S}_{w}}{V} δ t} ] ]} \dot{m} dt \qquad ( 27 )$$

In order to calculate the integral of equation (27), a number approximations will be made as indicated below.
The elementary change in time δt will be estimated as,

$$δ t \approx t - {t}_{0} . \qquad ( 28 )$$

The mass flow rate m will be replaced by the average flow rate,

$$\dot{m} \approx \frac{Δ m}{Δ t} , \qquad ( 29 )$$

with Δt=t₁−t₀ the change in time corresponding to the duration of the volume-estimating method.
The volume/area ratio of a tank 2, given by

$$\frac{V}{{s}_{w}} [ m ] ,$$

depends on the geometry of the tank 2. This ratio is uniform to a characteristic length, denoted

$${l}_{c} = \frac{V}{{s}_{w}} [ m ] .$$

This ratio may be bounded.
In the case of a tank 2 of spherical shape, the characteristic length l_{c} is minimal and is written as follows:

$${l}_{c} = \frac{{R}_{i n t}}{3} , \qquad ( 30 )$$

with Rᵢₙₜ [m] the internal diameter of the tank 2.
In the case of a tank 2 of cylindrical geometry, the characteristic length l_{c} may be written:

$${l}_{c} = \frac{{L}_{i n t} {R}_{i n t}}{2 ( {L}_{i n t} + {R}_{i n t} )} , \qquad ( 31 )$$

with Lᵢₙₜ [m] the internal length of the tank 2.
In the case where the internal length Lᵢₙₜ is very large compared to the internal diameter Rᵢₙₜ, the characteristic length is maximal,

$${l}_{c} = \frac{{R}_{i n t}}{2} , \qquad ( 32 )$$

Thus, based on the data provided in SAE J2601 [2], a value may be given to this characteristic length: l_{c}=0.066,0.171 m.

The value of the coefficient k_{g}[W/m²/K] of heat transfer between the gas and the wall of the tank is also unknown, as it depends on the geometry and materials of the tank 2, on the injector and on the mass flow rate. Based on calculations making the most extreme assumptions, it may be accepted that this value will remain below 10,000 W/m²/K.
The product

$${k}_{g} \frac{{s}_{w}}{V}$$

is defined via a single parameter Λ [W/m³/K] which will be assumed to remain the same.

$$Λ = {k}_{g} \frac{{s}_{w}}{V} , \qquad ( 33 )$$

Thus, using (27), (28), (29) and (33), the following is obtained:

$$V = \frac{1}{{t}_{1} - {t}_{0}} {\int }_{{t}_{0}}^{{t}_{1}} \frac{[ 1 - \frac{\partial ρ}{\partial T} \vert p [ \frac{( h ( p , {T}_{inj} ) - h ( p , T )}{ρ {c}_{p} + {k}_{g} \frac{{S}_{w}}{V} δ t} ] ]}{[ \frac{\partial ρ}{\partial p} \vert T + \frac{\partial ρ}{\partial T} \vert p [ \frac{β T}{ρ {c}_{p} + {k}_{g} \frac{{S}_{w}}{V} δ t} ] ]} dt \frac{Δ m}{Δ p} \qquad ( 34 )$$

with:
ρ [kg/m³] the density of the gas in the tank 2,
T [K] the temperature of the gas,
p [bar] the pressure of the gas,
t [s] time,
cₚ [J/K/kg] the heat capacity of the gas,
β [1/K] the isobaric expansion coefficient of the gas,
h [J/kg] the enthalpy of the gas,
Tᵢₙⱼ [K] the temperature of the injected gas,
Λ [W/m/K] a parameter taking into account the geometry and material of the tank 2.

### Namely:

$$X = \frac{1}{{t}_{1} - {t}_{0}} {\int }_{{t}_{0}}^{{t}_{1}} \frac{[ 1 - \frac{\partial ρ}{\partial T} \vert p [ \frac{( h ( p , {T}_{inj} ) - h ( p , T )}{ρ {c}_{p} + {k}_{g} \frac{{S}_{w}}{V} δ t} ] ]}{[ \frac{\partial ρ}{\partial p} \vert T + \frac{\partial ρ}{\partial T} \vert p [ \frac{β T}{ρ {c}_{p} + {k}_{g} \frac{{S}_{w}}{V} δ t} ] ]} dt , \\ and \\ Y = \frac{[ 1 - \frac{\partial ρ}{\partial T} \vert p [ \frac{( h ( p , {T}_{inj} ) - h ( p , T )}{ρ {c}_{p} + {k}_{g} \frac{{S}_{w}}{V} δ t} ] ]}{[ \frac{\partial ρ}{\partial p} \vert T + \frac{\partial ρ}{\partial T} \vert p [ \frac{β T}{ρ {c}_{p} + {k}_{g} \frac{{S}_{w}}{V} δ t} ] ]}$$

It will be noted that X is the temporal average of Y between t₁ and t₀.

The function V may take one of two forms V_{adia}, Vᵢₛₒ defined below, depending on the filling duration Δt:
when Δt tends towards zero (i.e. for filling performed in less than 5 s), the function V tends towards V_{adia}:

$${V}_{adia} = \frac{[ 1 - \frac{\partial ρ}{\partial T} \vert p [ \frac{( h ( p , {T}_{inj} ) - h ( p , T )}{ρ {c}_{p}} ] ]}{[ \frac{\partial ρ}{\partial p} \vert T + \frac{\partial ρ}{\partial T} \vert p [ \frac{β T}{ρ {c}_{p}} ] ]} \frac{Δ m}{Δ p} , \qquad ( 35 )$$

when Δt tends towards infinity (i.e. the filling duration is greater than 20 minutes), the function V tends towards Vᵢₛₒ:

$${V}_{iso} = \frac{1}{[ \frac{\partial ρ}{\partial p} \vert T ]} \frac{Δ m}{Δ p} , \qquad ( 36 )$$

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.
The singular forms “a”, “an” and “the” include plural referents, unless the context clearly dictates otherwise.
“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.
“Providing” in a claim is defined to mean furnishing, supplying, making available, or preparing something. The step may be performed by any actor in the absence of express language in the claim to the contrary.
Optional or optionally means that the subsequently described event or circumstances may or may not occur. The description includes instances where the event or circumstance occurs and instances where it does not occur.
Ranges may be expressed herein as from about one particular value, and/or to about another particular value. When such a range is expressed, it is to be understood that another embodiment is from the one particular value and/or to the other particular value, along with all combinations within said range.

1. A method for estimating the volume of a pressurized gas tank, the method comprising the following steps:
a) determining an initial pressure of the gas in the tank;
b) determining an initial temperature of the gas in the tank;
c) injecting a pressurized gas flow into the tank;
d) determining a temperature of injection of the gas flow into the tank;
e) determining the mass of the gas flow injected into the tank during the injecting step;
f) determining the variation in the pressure of the gas in the tank, between a final pressure determined at the end of the injecting step and the initial pressure determined at the beginning of the injecting step; and
g) calculating the volume of the tank depending on:
i. the initial pressure of the gas in the tank,
ii. the initial temperature of the gas in the tank,
iii, the temperature of injection of the gas flow into the tank,
iv. the mass of the gas flow injected into the tank,
V. the variation in the pressure of the gas in the tank;
wherein the calculating step also uses the duration (Δt) of the injecting step, said duration (Δt) being defined between a time (t₁) marking the end of the injecting step and a time (t₀) marking the beginning of the injecting step.

2. The method according to claim, wherein the calculating step also uses a predetermined parameter (Λ) taking into account both the geometry and the material of the tank.

3. The method according to claim, wherein the predetermined parameter (Λ) is the product of a characteristic length (l_{c}) of the tank multiplied by a coefficient (k_{g}) of heat transfer between the pressurized gas and an inner wall of the tank.

4. The method according to claim, wherein the characteristic length (l_{c}) has a value between a lower bound associated with a first reference tank of spherical shape, and an upper bound associated with a second reference tank of cylindrical shape.

5. The method according to claim, wherein the lower bound of the characteristic length (l_{c}) is equal to one third of a first internal radius (Rᵢₙₜ) of the first reference tank of spherical shape,
$$i . e . {l}_{c} = \frac{{R}_{i n t}}{3} ,$$
the upper bound of the characteristic length (l_{c}) being equal to half a second internal radius (Rᵢₙₜ) of the second reference tank of cylindrical shape,
$$i . e . {l}_{c} = \frac{{R}_{i n t}}{2} .$$

6. The method according to claim, wherein the coefficient of heat transfer (k_{g}) has a value between a predetermined lower bound equal to 150 W/m²/K, and a predetermined upper bound equal to 10,000 W/m²/K.

7. The method according to claim, wherein the step of determining the temperature (Tᵢₙⱼ) of injection of the gas into the tank is carried out using a temperature sensor placed in a refuelling station to which the tank is connected.

8. The method according to claim, wherein the initial temperature (T₀) is estimated to be equal to the ambient temperature in a region surrounding the tank.

9. The method according to claim, wherein the calculating step uses a mathematical function or formula (V) obtained from a mass and energy conservation balance of the gas injected into the tank.

10. The method according to claim, wherein the calculating step also uses a predetermined parameter (Λ) taking into account both the geometry and the material of the tank, wherein the function (V) is expressed as follows:
$$V = \frac{1}{{t}_{1} - {t}_{0}} {\int }_{{t}_{0}}^{{t}_{1}} \frac{[ 1 - \frac{\partial ρ}{\partial T} \vert p [ \frac{( h ( p , {T}_{inj} ) - h ( p , T )}{ρ {c}_{p} + Λ ( t - {t}_{1} )} ] ]}{[ \frac{\partial ρ}{\partial p} \vert T + \frac{\partial ρ}{\partial T} \vert p [ \frac{β T}{ρ {c}_{p} + Λ ( t - {t}_{1} )} ] ]} dt \frac{dm}{dp}$$
with
ρ [kg/m³] the density of the gas,
[K] the temperature of the gas,
p [bar] the pressure of the gas,
t [s] time,
cₚ [J/K/kg] the heat capacity of the gas,
β [1/K] the isobaric expansion coefficient of the gas,
h [J/kg] the enthalpy of the gas,
Tᵢₙⱼ [K] the temperature of the injected gas,
Λ [W/m³/K] a parameter taking into account the geometry and material of the tank.

11. The method according to claim, wherein the function (V) takes one of the following two forms (V_{adia}) and (Vᵢₛₒ) depending on the filling duration (Δt):
when the filling duration (Δt) tends towards zero, the function (V) takes the following form (V_{adia}):
$${V}_{adia} = \frac{[ 1 - \frac{\partial ρ}{\partial T} \vert p [ \frac{( h ( p , {T}_{inj} ) - h ( p , T ) )}{ρ {c}_{p}} ] ]}{[ \frac{\partial ρ}{\partial p} \vert T + \frac{\partial ρ}{\partial T} \vert p [ \frac{β T}{ρ {c}_{p}} ] ]} \frac{Δ m}{Δ p}$$
when the filling duration (Δt) tends towards infinity, the function (V) takes the following form (Vᵢₛₒ):
$${V}_{iso} = \frac{1}{[ \frac{\partial ρ}{\partial p} \vert T ]} \frac{Δ m}{Δ p}$$
